(19) United States
(12) Patent Application Publication
(10) Pub. No.: US 2024/0101071 A1
(43) Pub. Date: Mar. 28, 2024

(54) CLEANING DEVICE FOR AN ENVIRONMENT RECOGNITION DEVICE OF A VEHICLE AND ENVIRONMENT RECOGNITION DEVICE

(71) Applicant: Valeo Systèmes d'Essuyage, Le Mesnil Saint Denis (FR)

(72) Inventor: Radu-George Bute, Bietigheim-Bissingen (DE)

(73) Assignee: Valeo Systèmes d'Essuyage, Le Mesnil Saint Denis (FR)

(21) Appl. No.: 18/275,939

(22) PCT Filed: Feb. 4, 2022
(86) PCT No.: PCT/EP2022/052672

§ 371 Date: Aug. 4, 2023

(30) Foreign Application Priority Data
Feb. 4, 2021 (DE) 10 2021 102 620.2

(51) Int. Cl. B60S 1/56; B60S 1/52; B60S 1/54

(52) U.S. Cl. CPC B60S 1/56; B60S 1/528; B60S 1/544

(57) ABSTRACT

The invention relates to a cleaning device (10) for an environment recognition device (100) of a vehicle, the environment recognition device (100) comprising a sensor (104) having a vision window (106) to be cleaned, wherein the cleaning device (10) comprises at least one first cleaning element (12) designed as a spray nozzle (14) for applying a cleaning liquid (1) to the surface of the vision window (106), and comprising at least one second cleaning element (32) designed as a nozzle for generating compressed air that acts on the vision window (106).

### TECHNICAL FIELD

The invention relates to a cleaning device for an environment recognition device of a vehicle, as is used in particular as a constituent part of an at least partially autonomously, preferably fully autonomously driving vehicle. The invention also relates to an environment recognition device which comprises a cleaning device designed in accordance with the invention.

### PRIOR ART

DE 10 2018 105 618 A1 discloses a cleaning device for an environment recognition device of a vehicle having the features of the preamble of Claim 1. The known cleaning device is distinguished by at least one first cleaning element in the form of a fluid nozzle for spraying a cleaning liquid onto a vision window of the environment recognition device, and at least one second cleaning element in the form of an air nozzle which is also designed to act on the surface of the vision window in order to, for example, remove the previously sprayed-on cleaning fluid. Here, it is essential that the at least one first cleaning element and the at least one second cleaning element are arranged laterally next to a housing of the environment recognition device, which also bears the vision window to be cleaned. In this case, the two cleaning elements are positioned in a positionally fixed manner in so far as the cleaning of the vision window requires that the housing of the environment recognition device be rotated through 90°, for example from the original viewing direction for a sensor, so that the two cleaning elements can act on the vision window. This in turn means that, during the cleaning phase, the vision window and thus also the sensor of the environment recognition device are for example not oriented in a direction of travel, which restricts the use thereof.

### DISCLOSURE OF THE INVENTION

The cleaning device according to the invention for an environment recognition device of a vehicle having the features of Claim 1 has the advantage that the sensor and the vision window do not need to be moved from their original position, which makes it possible to monitor the environment, during the cleaning. At the same time, a relatively simple construction of the cleaning device in terms of apparatus is made possible.

To obtain the advantages mentioned above, it is therefore provided that the at least one first cleaning element and the at least one second cleaning element are designed to be arranged on a housing of the environment recognition device, wherein the at least one first cleaning element for spraying on the cleaning liquid is arranged so as to be adjustable in relation to the vision window from a standby position into an operating position, and wherein the at least one second cleaning element is arranged in a rigid position in relation to the vision window.

Advantageous refinements of the cleaning device according to the invention for an environment recognition device of a vehicle are specified in the subclaims.

A particularly effective action of the compressed air on the vision window is obtained if the at least one second cleaning element comprises a flat nozzle for guiding the compressed air onto the vision window, wherein the outlet cross section of the flat nozzle extends over the entire width or height of the vision window, and the flat nozzle is oriented in relation to the vision window in such a manner that the compressed air flowing onto the vision window impinges on the vision window at an oblique angle.

In a refinement of a flat nozzle designed or arranged in this way, it is provided that the flat nozzle is connected to the pressure side of a compressed air blower of radial type of construction by means of a supply line. This makes it possible to provide spatial separation between the flat nozzle and the pressure-generating device in a particularly simple manner.

In addition, it is very particularly preferable for the flat nozzle to be arranged above or to the side of the vision window at a small distance and outside the detection area of the sensor. This makes it possible to provide a minimal distance between the air outlet of the flat nozzle and the vision window, with the result that it is possible to achieve a minimal drop in pressure of the compressed air and the cleaning action on the vision window is thus optimized. At the same time, the sensor of the environment recognition device can continue to operate since the flat nozzle does not pass into the field of vision of the sensor.

With regard to the configuration of the spray nozzle for applying the cleaning liquid, it is preferably provided that the spray nozzle of the at least one first cleaning element is arranged at one end of a telescopic arm, and that, in the standby position, the at least one first cleaning element is arranged above the vision window at a small distance and outside the detection area of the sensor.

In a refinement of such a configuration, it is in particular provided that a plurality of first cleaning elements are provided which are arranged next to one another in each case at the same distance from the vision window, and that the plurality of first cleaning elements are arranged within a protective housing which extends over the entire width of the vision window.

In a refinement, an optimization of the cleaning action by the at least two cleaning elements with a simultaneously compact arrangement of the cleaning device is achieved if the at least one first cleaning element and the at least one second cleaning element are arranged above the vision window, and if the at least one first cleaning element is arranged above the at least one second cleaning element in relation to the vision window. In particular, such an arrangement makes it possible for the cleaning liquid applied to the vision window to be removed from the vision window not only by the compressed air but additionally by the action of gravity.

Furthermore, the invention also comprises an environment recognition device comprising an above-described cleaning device designed in accordance with the invention.

It is very particularly preferable for the sensor of the environment recognition device to be a lidar sensor which is arranged in a housing which comprises a vision window for the lidar sensor that delimits the field of vision of the lidar sensor.

In particular, in order to permit simple assembly and simple exchange of any defective components of the cleaning device, it is preferably provided that the components of the cleaning device are designed as attachments for the housing of the environment recognition device.

Further advantages, features and details of the invention will become apparent from the following description of preferred embodiments of the invention and with reference to the drawings.

### BRIEF DESCRIPTION OF THE DRAWINGS

FIG. 1 shows an environment recognition device comprising a cleaning device in a perspective illustration, in which the cleaning device is arranged in a standby position, and

FIG. 2 shows the environment recognition device as per FIG. 1, likewise in a perspective illustration, in an operating position of the cleaning device for the purpose of spraying cleaning liquid onto a vision window.

### EMBODIMENTS OF THE INVENTION

Identical elements or elements having an identical function are denoted by the same reference numbers in the figures.

An environment recognition device 100 for a vehicle (not illustrated) is shown in the figures, said environment recognition device in particular permitting an at least partially autonomous, preferably fully autonomous driving operation of the vehicle. For this purpose, the environment recognition device 100 is typically arranged on the roof of the vehicle or alternatively in a region of the vehicle that allows the area in front of the vehicle in the direction of travel of the vehicle to be detected.

By way of example, the environment recognition device 100 comprises an approximately cube-shaped housing 102 having a sensor 104, which is illustrated merely symbolically, arranged in the interior thereof. In particular, the sensor 104 is a lidar sensor which is used to detect objects located in the direction of travel of the vehicle. To this end, the housing 102 additionally comprises a vision window 106 which is transparent or transmissive to the wavelength of the sensor 104. In the exemplary embodiment illustrated, the vision window 106 simultaneously delimits the field of vision 108 of the sensor 104. By way of example, the vision window 106 has an at least approximately rectangular design with a width B and a height H in a subregion of a front end face of the housing 102, it being possible for said vision window to also have a curved form, for example.

A cleaning device 10 according to the invention for cleaning the vision window 106 is arranged above the housing 102 of the environment recognition device 100, that is to say on a roof region 110 of the housing 102. The components of the cleaning device 10, which are discussed in more detail below, are preferably designed as attachments for the housing 102, such that the components of the cleaning device 10 can be exchanged in a simple manner or assembled and/or removed in a simple manner.

The cleaning device 10 comprises at least one first cleaning element 12, preferably a plurality of first cleaning elements 12 each in the form of identical spray nozzles 14 for applying a cleaning liquid 1 to the vision window 106. For this purpose, the first cleaning elements 12 are arranged within an elongate and flat protective housing 16, for example in each case at the same distance from one another and parallel to the plane of the vision window 106.

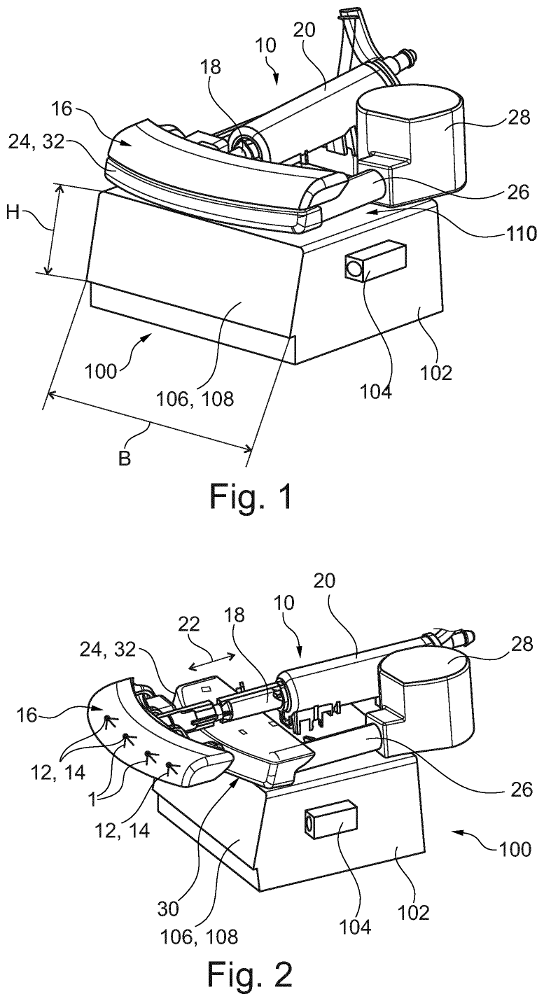

The protective housing 16 is arranged at the end of a telescopic arm 18 which is movable in the direction of the double arrow 22 in the longitudinal direction of the telescopic arm 18 by means of a telescopic drive 20. In particular, the telescopic drive 20 makes it possible to adjust the first cleaning elements 12 or the protective housing 16 from a standby position illustrated in FIG. 1 into an operating position illustrated in FIG. 2.

While the spray nozzles 14, which are connected to a supply source (not illustrated) for the cleaning liquid 1, cannot spray or dispense the cleaning liquid 1 onto the vision window 106 in the standby position when activated, the telescopic drive 20 makes it possible for the cleaning liquid 1 to be sprayed under pressure onto the vision window 106 either already during the adjustment from the standby position into the operating position, but at least when the operating position is reached, in order to remove dirt or similar, elements that influence the vision of the sensor element 104, from the vision window 106.

In addition, arranged between the top side of the housing 102 of the environment recognition device 100 and the telescopic arm 18 or the protective housing 16 for the first cleaning elements 12 is a housing of a flat nozzle 24 which is connected to the pressure side of a compressed air blower in the form of a radial blower 28 by means of a supply line 26. The flat nozzle 24 is arranged so as to be positionally fixed in relation to the housing 102 and comprises an outlet region 30 which is oriented in such a manner that compressed air flowing out of the flat nozzle 24 impinges on the vision window 106 at an oblique angle in order to scrape off medium located on the vision window 106.

The flat nozzle 24 constitutes a second cleaning element 32. Furthermore, the flat nozzle 24 extends over the entire width B of the vision window 106 or of the housing 102.

In the exemplary embodiment illustrated in FIGS. 1 and 2, the protective housing 16 and the flat nozzle 24 for the cleaning elements 12, 32 are arranged above the vision window 106 or extend parallel to the top side of the housing 102. It goes without saying that it is also conceivable for the protective housing 16 and/or the flat nozzle 24 for the cleaning elements 12, 32 to be arranged on the housing 102 to the side of the vision window 106, such that the protective housing 16 and the flat nozzle extend in a vertical direction. In this case, the protective housing 16 and the flat nozzle 24 may also be arranged on opposite sides of the vision window 106.

However, it is preferable for the protective housing 16 and the flat nozzle 24 to be arranged in such a manner that they have a close spacing to one another or are located in the same region of the housing 102 of the environment recognition device 100. It goes without saying that it is also conceivable for the sensor 104 used to be, for example, a camera-based device or similar instead of a lidar sensor.

### REFERENCE DESIGNATIONS

1 Cleaning liquid
10 Cleaning device
12 First cleaning element
14 Spray nozzle
16 Protective housing
18 Telescopic arm
20 Telescopic drive
22 Double arrow
24 Flat nozzle
26 Supply line
28 Radial blower
30 Outlet region
32 Second cleaning element
100 Environment recognition device
102 Housing
104 Sensor
106 Vision window
108 Field of vision
110 Roof region
B Width
H Height

1. A cleaning device for an environment recognition device of a vehicle, the environment recognition device comprising a sensor including a vision window to be cleaned, the cleaning device comprising:
at least one first cleaning element realized as a spray nozzle for applying a cleaning liquid to the surface of the vision window; and
at least one second cleaning element realized as a nozzle for generating compressed air acting on the vision window,
wherein the at least first and second cleaning elements are configured to be disposed on a housing of the environment recognition device,
wherein the at least one first cleaning element for spraying on the cleaning liquid is disposed so as to be displaceable in relation to the vision window from a standby position into an operation position, and wherein the at least one second cleaning element is disposed in a rigid position in relation to the vision window.

2. The cleaning device according to claim 1, wherein the at least one second cleaning element has a flat nozzle for guiding the compressed air onto the vision window, wherein the outlet cross section of the flat nozzle extends over the entire width or height of the vision window, and the flat nozzle is aligned in relation to the vision window in such a manner that compressed air flowing onto the vision window reaches the vision window at an oblique angle.

3. The cleaning device according to claim 2, wherein the flat nozzle is connected to the pressure side of a compressed air blower having a radial design by means of a supply line.

4. The cleaning device according to claim 2, wherein the flat nozzle is disposed above or next to the vision window at a small distance and outside the detection area of the sensor.

5. The cleaning device according to claim 1, wherein the spray nozzle of the at least one first cleaning element is disposed at one end of a telescopic arm, and that the at least one first cleaning element is disposed above the vision window at a small distance and outside the detection area of the sensor in the standby position.

6. The cleaning device according to claim 5, wherein several first cleaning elements are provided which are disposed next to one another at the same distance to the vision window, and that the several first cleaning elements are disposed inside a protective housing which extends over the entire width of the vision window.

7. The cleaning device according to claim 6, wherein the at least one first cleaning element and the at least one second cleaning element are disposed above the vision window, and that the at least one first cleaning element is disposed above the at least one second cleaning element in relation to the vision window.

8. An environment recognition device having a cleaning device realized according to claim 1.

9. The environment recognition device according to claim 8, wherein the sensor of the environment recognition device is a lidar sensor which is disposed in a housing which has a vision window for the lidar sensor.

10. The environment recognition device according to claim 8, wherein the components for the cleaning device are configured as attachments for the housing.
